(19) United States
(12) Patent Application Publication
(10) Pub. No.: US 2026/0323744 A1
(43) Pub. Date: Oct. 15, 2026

(54) LOAD HANDLING DEVICE

(71) Applicant: Ocado Innovation Limited, Hatfield (GB)

(72) Inventors: Di KONG, London (GB); Geoff PATTERSON, London (GB)

(21) Appl. No.: 19/461,860

(22) Filed: Jan. 28, 2026

Related U.S. Application Data
(63) Continuation of application No. PCT/EP2024/072085, filed on Aug. 2, 2024.

(30) Foreign Application Priority Data
Aug. 4, 2023 (GB) 2311965.4
Aug. 4, 2023 (GB) 2311974.6
Nov. 30, 2023 (GB) 2318344.5

(51) Int. Cl. H04W 76/15; B65G 1/04; H04W 88/08

(52) U.S. Cl. CPC H04W 76/15; B65G 1/0464; H04W 88/08

(57) ABSTRACT

A load handling device designed to operate on the top of a cubic automated storage and retrieval system (ASRS). The load handling device comprises two wireless network interfaces which can be bonded into a single wireless connection with a wireless access point. In use, one of the wireless network interfaces can be used to connect to a further wireless access point. Data may then flow from the ASRS to the load handling device via the further wireless access point. The bonded connection may then be re-configured to connect via the further wireless access point.

### RELATED APPLICATIONS

This application is a continuation of International Patent Application PCT/EP2024/072085 entitled “Load Handling Device” filed 2 Aug. 2024, which claims priority to (i) UK Patent Application No. GB2318344.5 entitled “Load Handling Device” filed 30 Nov. 2023, (ii) UK Patent Application No. GB 2311974.6 entitled “Automated Storage & Retrieval System” filed 4 Aug. 2023, and (iii) UK Patent Application No. GB2311965.4 filed 4 Aug. 2023 and entitled “Load Handling Device”; the entire contents of all of which applications are incorporated herein by reference.

### FIELD OF THE DISCLOSURE

The disclosure relates to a method of operating a load-handling device, and in particular to a method of operating a load-handling device within a storage and retrieval system.

### BACKGROUND

Grid-based automatic storage and retrieval systems are well known in the art. In such systems a plurality of robotic load handlers operate on a horizontal grid structure, underneath which is received a plurality of containers, arranged in a plurality of stacks. The containers are used to hold products and the load handlers are adapted to retrieve containers from one of the plurality of stacks and to deposit a container within one of the stacks. The load handlers may be routed in an autonomous manner (or a semi-autonomous manner) on the grid but a wireless communications system is required to transmit instructions to load handlers and to enable each of the load handlers to communicate with a management system. The claimed apparatus, methods, systems and computer programs are intended to provide improvements relating to communications systems for use in an automated retrieval and storage system which uses a fleet of robotic load handlers.

### SUMMARY

According to a first aspect of the present disclosure, there is provided a method of operating a load-handling device within a storage and retrieval system, the method comprising the steps of: a) establishing a first wireless connection between the load-handling device and a first wireless access point, wherein i) the load-handling device comprises a first wireless interface and a second wireless interface, ii) the first wireless connection is a bonded connection used to transfer data between the storage and retrieval system and the load-handling device via the first wireless access point; iii) the first wireless interface and the second wireless interface are both bonded to the first connection, wherein the first wireless interface is an active interface and the second wireless interface is a backup interface; b) establishing a second wireless connection between the load handling device and a second wireless access point when one or more conditions are met, such that; iv) the second wireless interface is removed from the bonded first wireless connection; v) the second wireless connection is made between the second wireless interface of the load handling device and the second wireless access point.

Data may be transferred between the storage system and the load handling device via the second wireless access point and the second wireless connection. Furthermore, no data may then be transferred between the storage system and the load handling device via the first wireless access point. Subsequently, the first wireless interface may end the wireless connection with the first wireless access point and make a wireless connection to the second wireless access point. The first wireless interface and the second wireless interface may both be connected via a bonded connection, wherein the second wireless interface is an active interface and the first wireless interface is a backup interface. The bonded wireless connection may be reconfigured such that the first wireless interface is the active interface and the second wireless interface is the backup interface and thus data is transferred between the storage system and the load handling device via the second wireless connection and the first wireless interface.

It has been found that the present method enables a significant decrease in the time required for a load handling device to be handed over from one wireless access point to a further wireless access point. It has been found that using conventional WiFi roaming techniques (for example, those described in IEEE 802.11r, k, v), a WiFi handover took up to 1200 ms. In contrast, the present method enables a WiFi handover in up to 200 ms. Such a secretase is very significant in applications that require low latency, such as the operation of the load handling devices in ASRSs. Furthermore, the present method provides enhanced resilience when compared with known methods.

The received signal strength of the first wireless access point and/or the received signal strength of the second wireless access point may be used in step b) as a condition that is used to establish the second wireless connection. Furthermore, or in an alternative, the error rate in the first wireless connection may be used in step b) as a condition that is used to establish the second wireless connection.

According to a second aspect of the present disclosure, there is provided a load handling device for use in a storage system, the load handling device comprising a first network interface and a second network interface, the load handling device being configured, in use, to perform a method as described above. The load handling device may further comprise a wheel assembly arranged to selectively move in one of two orthogonal directions and a container lifting device arranged, in use, to lift a container from one of the plurality of stacks into the interior of the load handling device

According to a third aspect of the present disclosure, there is provided a storage system comprising: a first set of parallel rails extending in an X-direction, and a second set of parallel rails extending in a Y-direction transverse to the first set in a substantially horizontal plane to form a grid pattern comprising a plurality of grid spaces; a plurality of stacks of containers located beneath the rails, and arranged such that each stack is located within a footprint of a single grid space; at least one load handling device according to claim 9 or claim 10, the at least one load handling device being arranged to selectively move in the X and/or Y directions, above the stacks on the rails and arranged to transport a container. The at least one load handling device may have a footprint that occupies only a single grid space in the storage system, such that a load handling device occupying one grid space does not obstruct a load handling device occupying or traversing the adjacent grid spaces in the X and/or Y directions.

### BRIEF DESCRIPTION OF THE DRAWINGS

Examples of communication systems in accordance with the present disclosure will now be described in detail with reference to the accompanying drawings, in which:

FIG. 1 schematically illustrates a storage structure and containers;

FIG. 2 schematically illustrates track on top of the storage structure illustrated in FIG. 1;

FIG. 3 schematically illustrates load-handling devices on top of the storage structure illustrated in FIG. 1;

FIG. 4 schematically illustrates a single load-handling device with container-lifting unit in a lowered configuration;

FIG. 5 schematically illustrates cutaway views of a single load-handling device with container-lifting unit in a raised and a lowered configuration;

FIG. 6 shows a schematic depiction of a communication system according to the present disclosure;

FIG. 7 shows a schematic depiction of a bot for use with the communication system of the present disclosure;

FIG. 8 shows a schematic depiction of a grid which is covered by a first coverage area and a second coverage area;

FIG. 9 shows a schematic depiction of a bot after it has moved on the grid;

FIG. 10 shows a schematic depiction of the bot after a decision has been made to transfer the wireless connection to the second wireless access point;

FIG. 11 shows a schematic depiction of the bot after data is being routed via the second wireless access point;

FIG. 12 shows a schematic depiction of the bot where the bonded wireless interface is reconfigured such that it connects to the second wireless access point;

FIG. 13 shows a schematic depiction of the situation where the bonded wireless interface is further re-configured;

FIG. 14 shows a schematic depiction of an optional additional step, in which the bonded wireless interface further re-configured; and

FIG. 15 shows a flow chart which provides a graphical depiction of a method according to the present disclosure.

### DETAILED DESCRIPTION

The following examples represent the applicant's preferred examples of how to implement a communications system for use with robots in a warehouse but they are not necessarily the only examples of how that could be achieved.

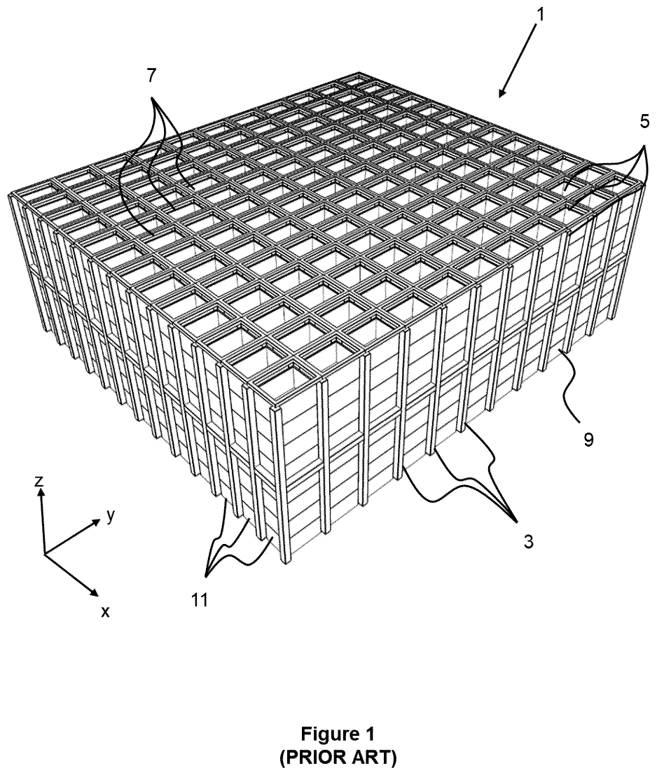

FIG. 1 illustrates a storage structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, containers 9 are arranged in stacks 11 beneath the grid cells defined by the grid pattern, one stack 11 of containers 9 per grid cell.

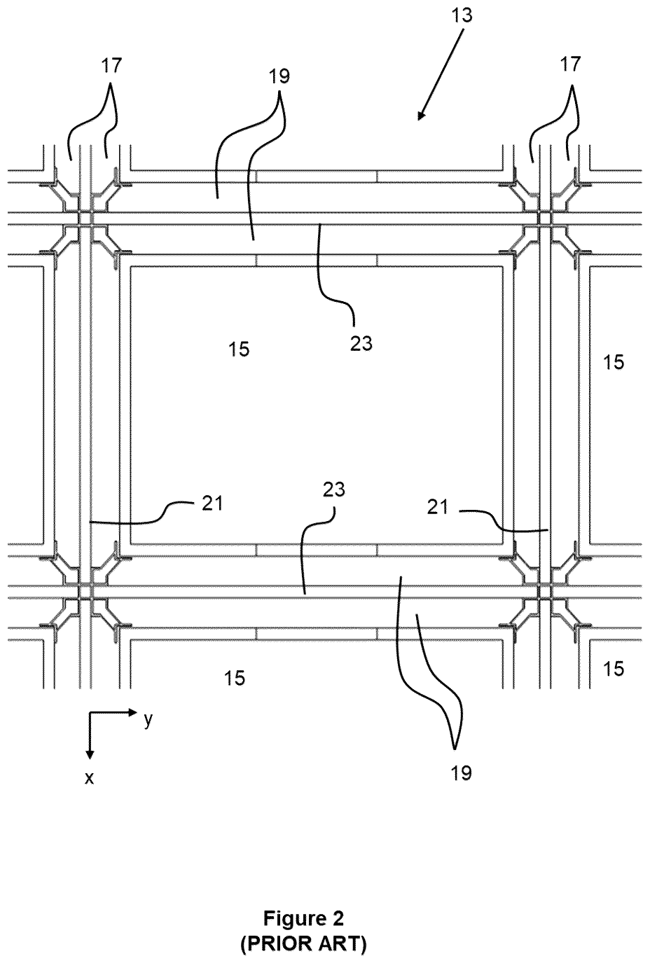

FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

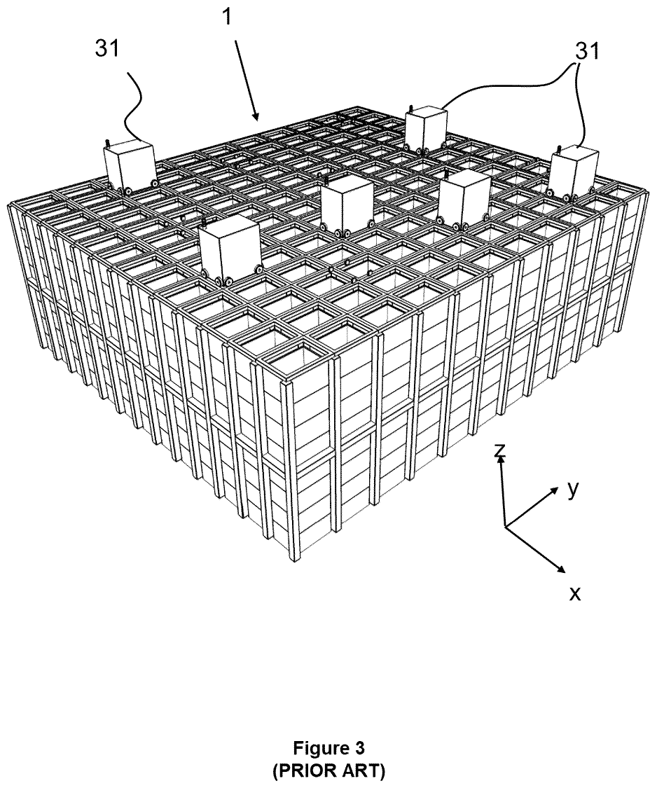

FIG. 3 shows a plurality of load-handling devices 31 moving on top of the storage structure 1 illustrated in FIG. 1. The load-handling devices 31, which may also be referred to as robots 31 or bots 31, are provided with sets of wheels to engage with corresponding x-or y-direction tracks 17, 19 to enable the bots 31 to travel across the track structure 13 and reach specific grid cells. The illustrated pairs of tracks 17, 19 separated by channels 21, 23 allow bots 31 to occupy (or pass one another on) neighbouring grid cells without colliding with one another.

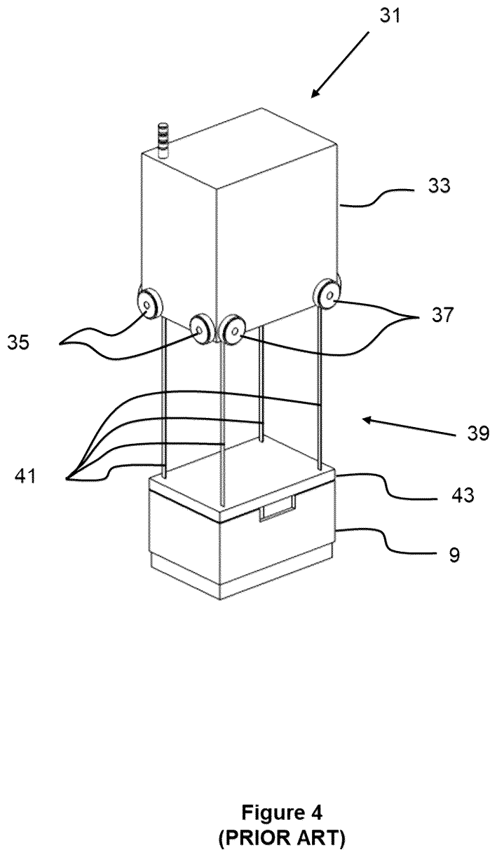

As illustrated in detail in FIG. 4, a bot 31 comprises a body 33 in or on which are mounted one or more components which enable the bot 31 to perform its intended functions. These functions may include moving across the storage structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises first and second sets of wheels 35, 37 which are mounted on the body 33 of the bot 31 and enable the bot 31 to move in the x-and y-directions along the tracks 17 and 19, respectively. In particular, two wheels 35 are provided on the shorter side of the bot 31 visible in FIG. 4, and a further two wheels 35 are provided on the opposite shorter side of the bot 31 (side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19.

The bot 31 also comprises container-lifting unit 39 configured to raise and lower containers 9. The illustrated container-lifting unit 39 comprises four tapes or reels 41 which are connected at their lower ends to a container-engaging assembly 43. The container-engaging assembly 43 comprises engaging mechanism (which may, for example, be provided at the corners of the assembly 43, in the vicinity of the tapes 41) configured to engage with features of the containers 9. For instance, the containers 9 may be provided with one or more apertures in their upper sides with which the engaging mechanism can engage. Alternatively or additionally, the engaging mechanism may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

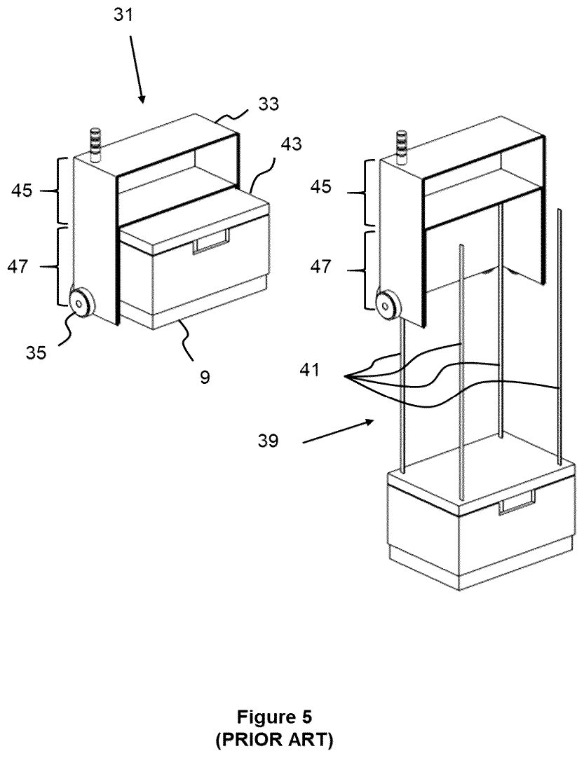

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45. The lower portion 47 comprises a container-receiving space or cavity for accommodating at least part of a container 9 that has been raised by the container-lifting unit 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting unit 39 controls the tapes 41 to lower the container-gripping assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, the upper and lower portions 45, 47 may not be physically divided by a specific component or part of the body 33 of the bot 31.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

To remove a container 9 from the top of a stack 11, the bot 31 is moved as necessary in the X and Y directions so that the container-gripping assembly 43 is positioned above the stack 11. The container-gripping assembly 43 is then lowered vertically in the Z direction to engage with the container 9 on the top of the stack 11. The container-gripping assembly 43 grips the container 9, and is then pulled upwards on the tapes 41, with the container 9 attached. At the top of its vertical travel, the container 9 is accommodated within the vehicle body and is held above the level of the tracks. In this way, the load handling device 30 can be moved to a different position in the X-Y plane, carrying the container 9 along with it, to transport the container 9 to another location. The tapes 41 are long enough to allow the load handling device 30 to retrieve and place containers from any level of a stack 11, including the floor level. The weight of the vehicle may be comprised in part of batteries that are used to power the drive mechanism for the wheels 35, 37.

As shown in FIG. 3, a plurality of load handling devices 31 are provided, so that each bot 31 can operate simultaneously to increase the throughput of the system. The system illustrated in FIG. 3 may include specific locations, known as ports, at which containers 9 can be transferred into or out of the system. An additional conveyor system (not shown) is associated with each port, so that containers 9 transported to a port by a bot 31 can be transferred to another location by the conveyor system, for example to a picking station (not shown). Similarly, containers 9 can be moved by the conveyor system to a port from an external location, for example to a container-filling station (not shown), and transported to a stack 11 by the bots 31 to replenish the stock in the system.

Each bot 31 can lift and move one container 9 at a time. If it is necessary to retrieve a container (“target container”) that is not located on the top of a stack 11, then the overlying containers (“non-target containers”) must first be moved to allow access to the target container. This is achieved in an operation referred to hereafter as “digging”. During a digging operation, one of the bots 31 sequentially lifts each non-target container 9a from the stack 11 containing the target container 9b and places it in a vacant position within another stack 11. The target container 9b can then be accessed by the bot 31 and moved to a port for further transportation.

Each of the bots 31 is under the control of a grid controller. Each individual container 9 in the system is tracked, so that the appropriate containers 9 can be retrieved, transported and replaced as necessary. For example, during a digging operation, the locations of each of the non-target containers is logged, so that the non-target containers can be tracked.

The system described with reference to FIGS. 1 to 5 has many advantages and is suitable for a wide range of storage and retrieval operations. In particular, it allows very dense storage of product, and it provides a very economical way of storing a huge range of different items in the containers 9, while allowing reasonably economical access to all of the containers 9 when required for picking.

It should be understood that it is necessary for messages to be transmitted to the bots. These may be short messages, for example an instruction to move a container from a first location to a second location, or the messages may be larger, for example an update to the computer code which is used to operate the bot or a component of the bot. Similarly, it may be necessary for the bot to send messages to a central management system, for example to report operating parameter values, operating state reports etc. An example of a communications system which can be used is disclosed in the Applicant's international patent application WO 2015/185726 and the corresponding U.S. Pat. Nos. 10,805,933 and 12,016,946, the entire contents of both of which are incorporated herein by reference.

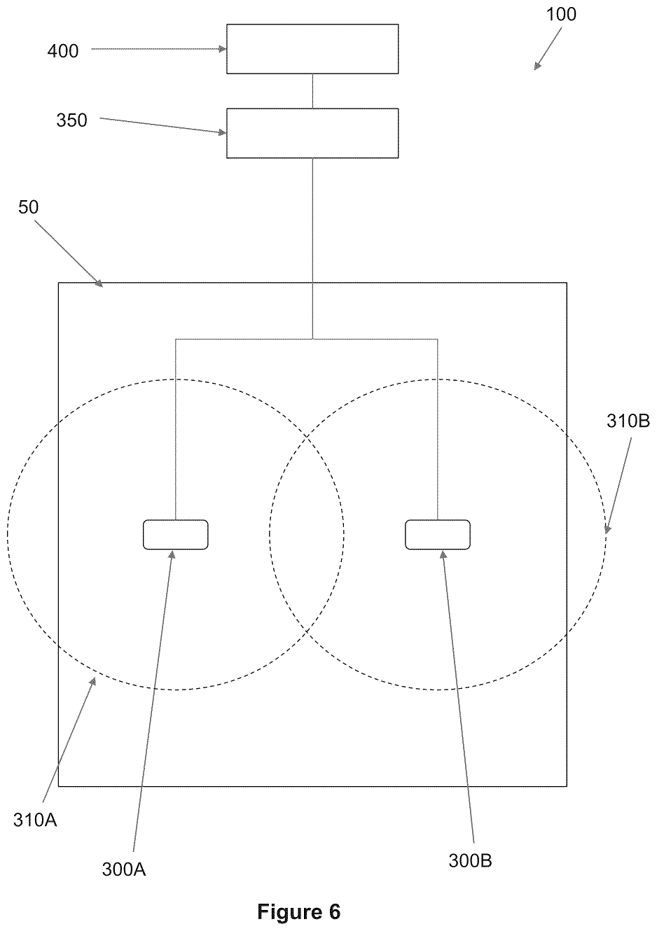

FIG. 6 shows a schematic depiction of a communication system 100 according to the present disclosure in which a fulfilment centre comprises a grid 50 upon which a plurality of bots 31 (not shown) move and operate, as described above with reference to FIGS. 1 to 5. The communication system 100 comprises two wireless access points 300A, 300B, each of which has an associated coverage area 310A, 310B (shown by the dashed lines). Each of the wireless access points 300A, 300B are connected to a gateway 350, which is in turn communicably connected to a central computing system 400.

It should be understood that the shape of the coverage area is merely illustrative and not intended to be representative of the coverage area that will be achieved by a communication system according to the present disclosure. It can be seen that the first coverage area 310A overlaps with the second coverage area 310B for a portion of the grid. It can also be seen that not all of the grid is covered by coverage areas 310A, 310B but it will be understood that the communication system 100 comprises further access points which are not shown in FIG. 6 such that the entirety of the grid surface is covered by at least one access point.

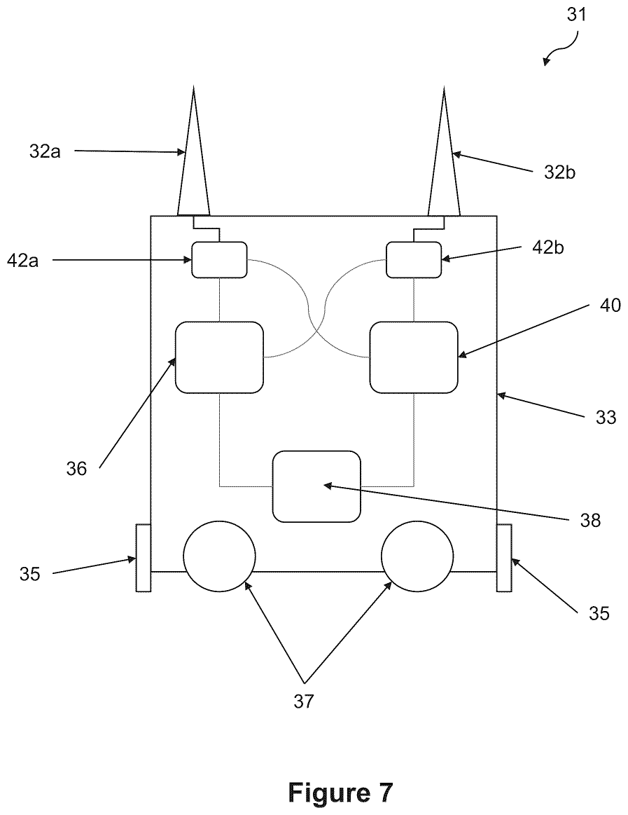

Notwithstanding the discussion above with respect to FIGS. 4 & 5, FIG. 7 shows a schematic depiction of a bot 31 for use with the communication system of the present disclosure. The bot 31 further comprises first wireless antenna 32a, second wireless antenna 32b, first wireless network card 42A, second wireless network card 42B, safety receiver 36, real time controller 38 and bot PC 40. The first and second antennae 32a 32b which are located on the exterior of the bot body 33 and are configured to receive signals transmitted by an access point. The first wireless antenna 32a is connected to the first wireless network card 42A such that data received via the first wireless network card 42A is routed to the safety receiver 36 and the bot PC 40. Similarly, the second wireless antenna 32b is connected to the second wireless network card 42B such that data received via the second wireless network card 42B is routed to the safety receiver 36 and the bot PC 40.

In an alternative configuration, each of the first and second wireless network cards 42A 42B may be connected to a respective antenna group. In one example, each of the first and second wireless network cards 42A 42B may be connected to a respective antenna group comprising two antennae, such that each antenna in an antenna group can be used to form a spatial stream.

The signals received by the bot will comprise both control signals and safety signals. In one example, the control signals may be generated and transmitted separately from the safety signals. In an alternative example, the control signals and the safety signals may be transmitted together as a composite signal. In such a case, additional components may be provided (not shown in FIG. 7) to separate the control signals and the safety signals.

The received control signals are processed by the bot PC 40. The bot PC 40 is in communication with the first and second sets of wheels 35, 37 and can send signals to activate the first or second sets of wheels as appropriate. The bot PC 40 is also in communication with the container-lifting unit 39 (see FIGS. 4 & 5) and can control the container-lifting unit to, for example, lift a container from a stack within the grid structure into the bot, to lower a container from within the bot into a stack within the grid, etc. Thus, the bot PC is able to interpret and execute the control signals such that the bot can be operated in an efficient manner as a part of the plurality of bots operating on the surface of the grid. A PC may include multiple linked CPUs, i.e., a CPU may be composed of one or more linked, networked, or cooperating processing units/devices.

The received safety signals are processed by the safety receiver 36. If a safety condition is detected by the safety receiver, then the safety receiver may cause the real time controller 38 to send a safety control signal to the bot PC 40. The reception of the safety control signal from the real time controller overrides the control signals received by the bot PC from the grid controller such that the operations of the bot are stopped. If the bot is in the process of moving from a first grid location to a second grid location, then the bot will be stopped at its current location. A stationary bot which is in the process of lifting or lowering a container may complete that action but will not take any further action until the safety control signal is overridden.

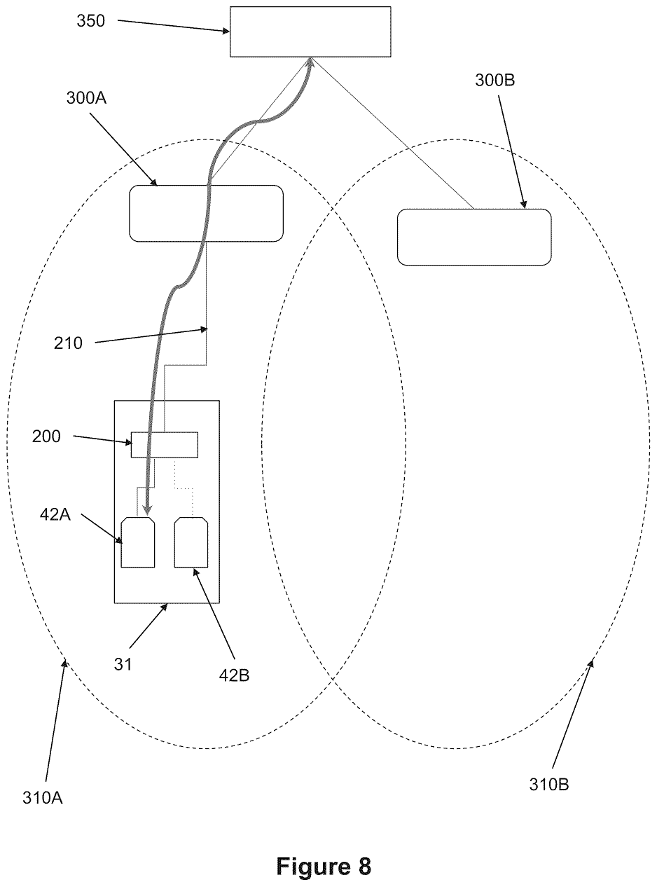

FIG. 8 shows a schematic depiction of a bot 31 which is located within the coverage area 310A of first wireless access point 300A. The bot has formed a wireless connection with the gateway 350 via the first wireless access point 300A. For the sake of clarity, the grid 50 and the central computing system 400 have been excluded from FIG. 8. Similarly, FIG. 8 only shows first and second wireless access points 300A 300B and their respective coverage areas 310A 310B but it will be appreciated that further wireless access points may be present.

In operation, the bot has established a wireless connection 210 with wireless access point 300A as the bot is within the coverage area 310A. The bot has used both the first wireless network card 42A and the second wireless network card 42B to create a bonded network connection to the first wireless access point. The bonded connection is formed to provide increased resilience. In the example shown in FIG. 8, a bonded wireless interface 200 is established within the bot and the first wireless network card 42A is an active secondary network interface, which is used to transmit data to, and receive data from, the first wireless access point. The second wireless network card 42B is a back-up secondary network interface, which can be used to send and receive data in the event that there is a fault with the first wireless network card 42A. The active secondary network interface is indicated by a solid line from the first wireless network card 42A to the bonded wireless interface 200. The back-up secondary network interface is indicated by a dotted line from the second wireless network card 42B to the bonded wireless interface 200. In the event that the first wireless network card 42A fails then the bonded wireless interface 200 can be re-configured to route data via the second wireless network card, enabling the data to be re-routed with minimal loss, and hence a minimal impact on the efficiency of operation of the storage and retrieval system. In FIG. 8, the flow of data between the gateway 350 and the bot is shown figuratively using the heavy arrowed line.

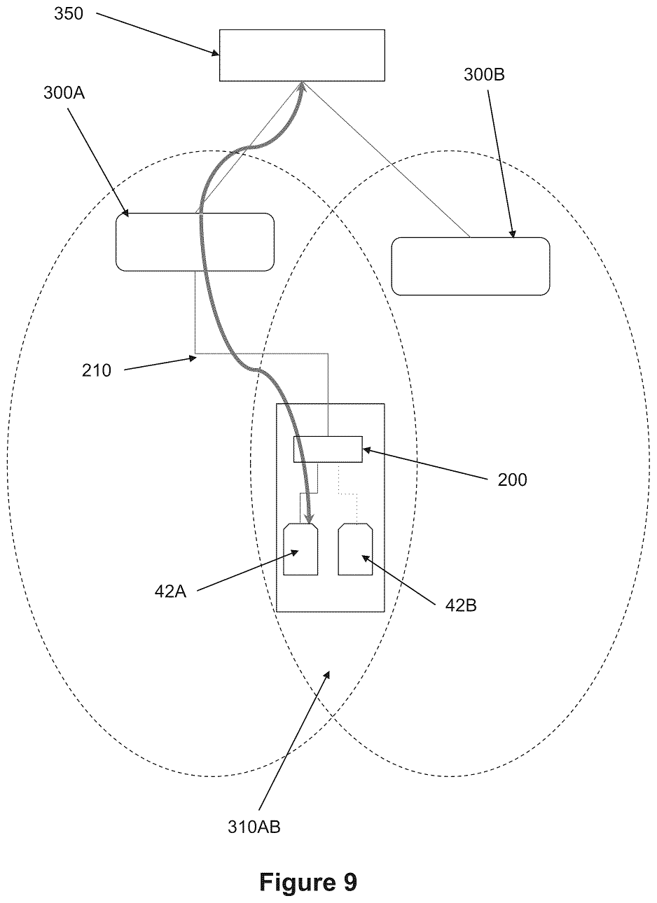

FIG. 9 shows a schematic depiction of the bot described above with reference to FIG. 8 after it has moved on the grid. The bot has moved into region 310AB, which is the region which is covered by both first wireless access point 300A and second wireless access point 300B. As the bot is still within range of the first wireless access point 300A then the wireless connection 210 to the first wireless access point 300B is maintained.

As the bot is also within the coverage of the second wireless access point 300B then it may decide to transfer the connection from the first wireless access point 300A to the second wireless access point 300B. The decision to transfer the wireless connection may be made on the basis of one or more transmission parameters. For example, the RSSI (Received Signal Strength Indicator) value for the first wireless access point 300A may have fallen below a first predetermined threshold value and/or the RSSI (Received Signal Strength Indicator) value for the second wireless access point 300B may exceed a second predetermined threshold value. Alternatively, or in addition, the packet loss values associated with the first wireless access point and/or the second wireless access point may be used in determining whether to transfer the wireless connection. It should be understood that other parameters may be used in addition, or as an alternative, to these parameters and that the basis for the decision to transfer the wireless connection is not critical to the present disclosure.

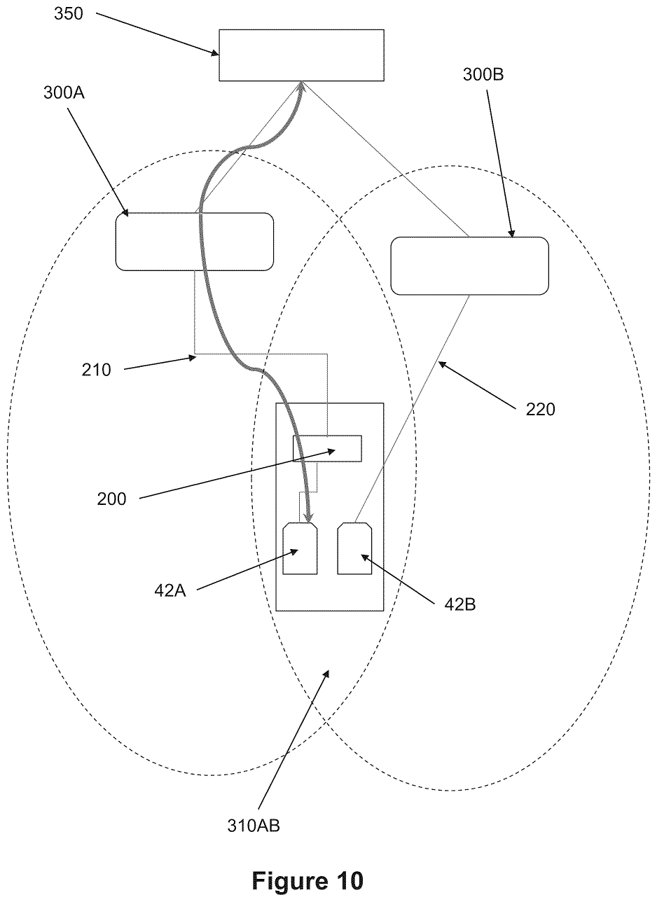

FIG. 10 shows a schematic depiction of the bot described above with reference to FIGS. 8 & 9 after a decision has been made to transfer the wireless connection to the second wireless access point 300B. The second wireless network card 42B is used to make a wireless connection 220 with the second wireless access point 300B. The wireless connection 210 to the first wireless access point is maintained and data continues to flow between the gateway and the bot via the first wireless access point, as is shown figuratively by the heavy arrowed line.

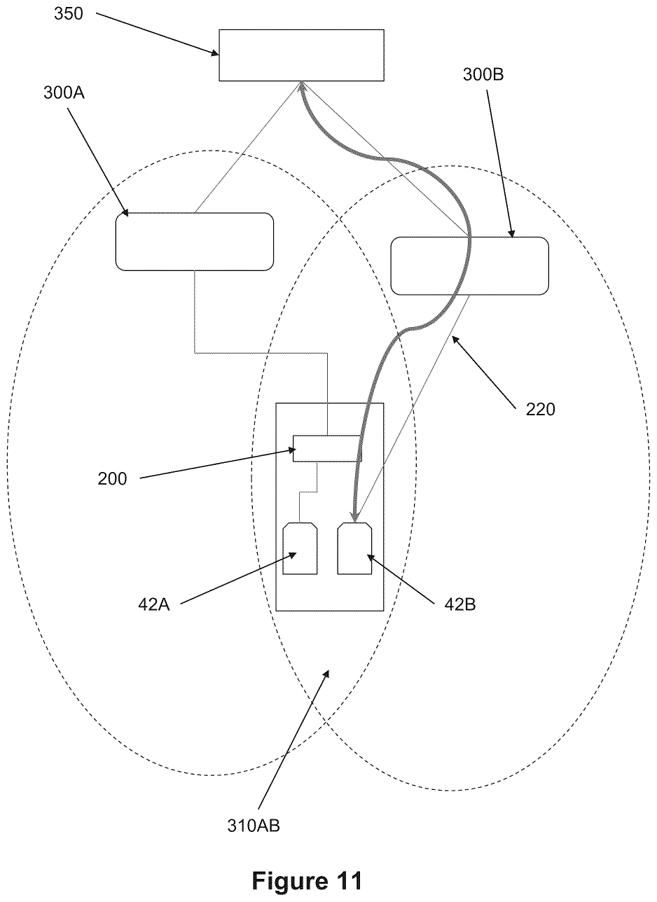

The next step of the process is shown in FIG. 11. The gateway routes the data flow to the second wireless network card 42B of the bot via the second wireless action point 300B and wireless connection 220. The data flow is shown figuratively by the heavy arrowed line. It can be seen that as the network reconfiguration requires that the data is transmitted via the second wireless action point 300B rather than via the first wireless action point 300A the reconfiguration can be performed quickly, minimising any data loss. It can be seen that the wireless connection 210 between the first wireless network card 42A and the first wireless access point is still maintained at this point, to assist in the efficient transfer to the second wireless action point 300B.

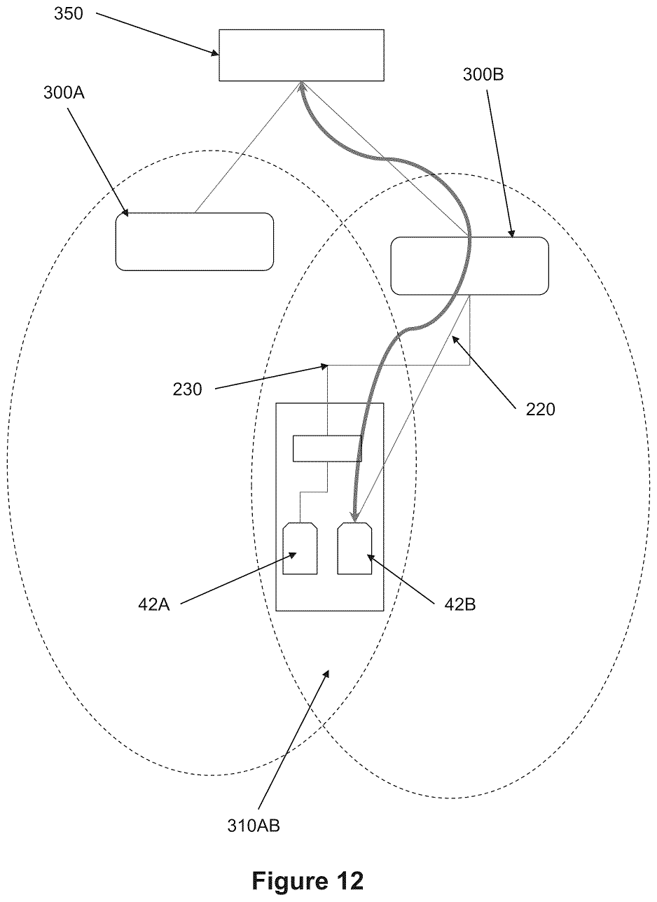

FIG. 12 shows the situation where the bonded wireless interface is reconfigured such that it connects to the second wireless access point. This means that the first wireless network card 42A is now also connected to the second wireless action point via further wireless connection 230. It can be seen that the data flow to the bot continues to be routed via the second wireless network card 42B.

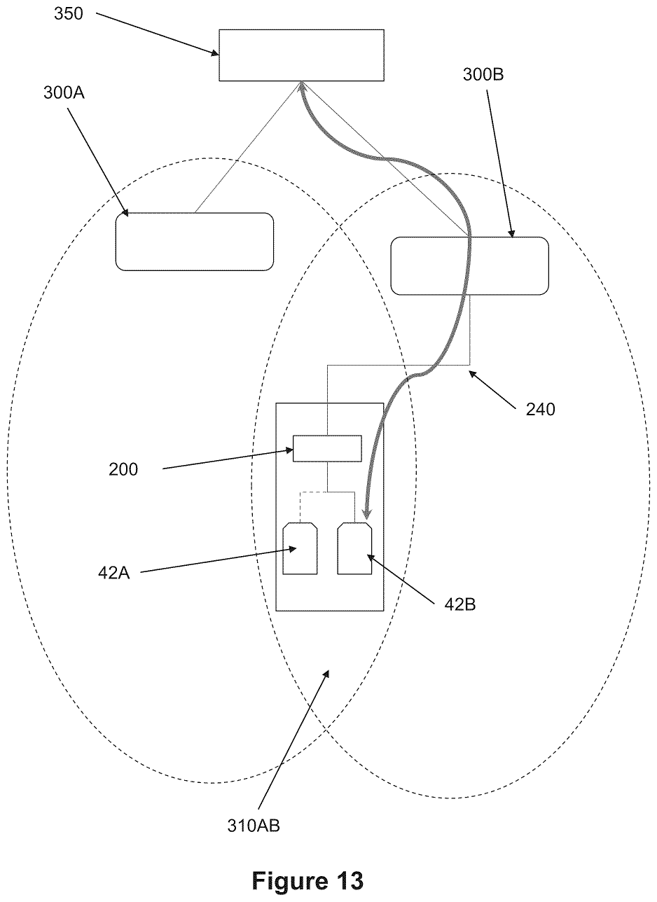

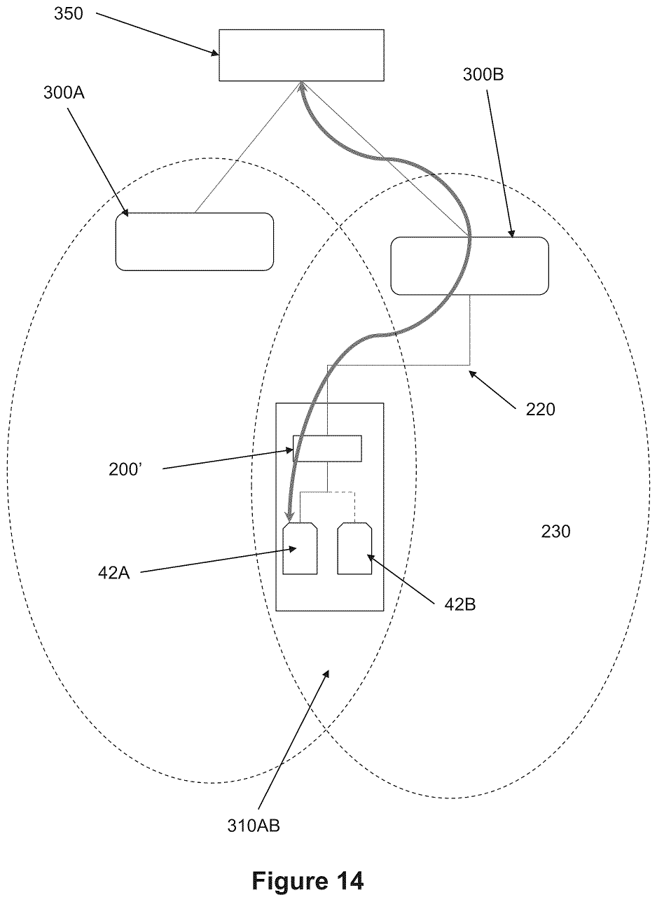

FIG. 13 shows the situation where the bonded wireless interface 200 is further re-configured such that a single bonded connection 240 is formed between the bot and the second wireless access point 300B. The second wireless network card 42B is an active secondary interface such that data is transmitted between the bot and the gateway via the second wireless network card 42B and the second wireless access point 300B. The first wireless network card 42A is a back-up secondary interface such that data may be routed to the first wireless network card 42A in the event of a failure of the second wireless network card 42B. FIG. 14 shows a schematic depiction of an optional additional step, in which the bonded wireless interface 200 is re-configured such that the first wireless network card 42A becomes the active secondary interface (shown by the solid line in FIG. 14) and the second wireless network card 42B becomes the back-up secondary interface (shown by the dotted line). Again, the flow of data between the gateway and the bot is shown figuratively by the heavy arrowed line.

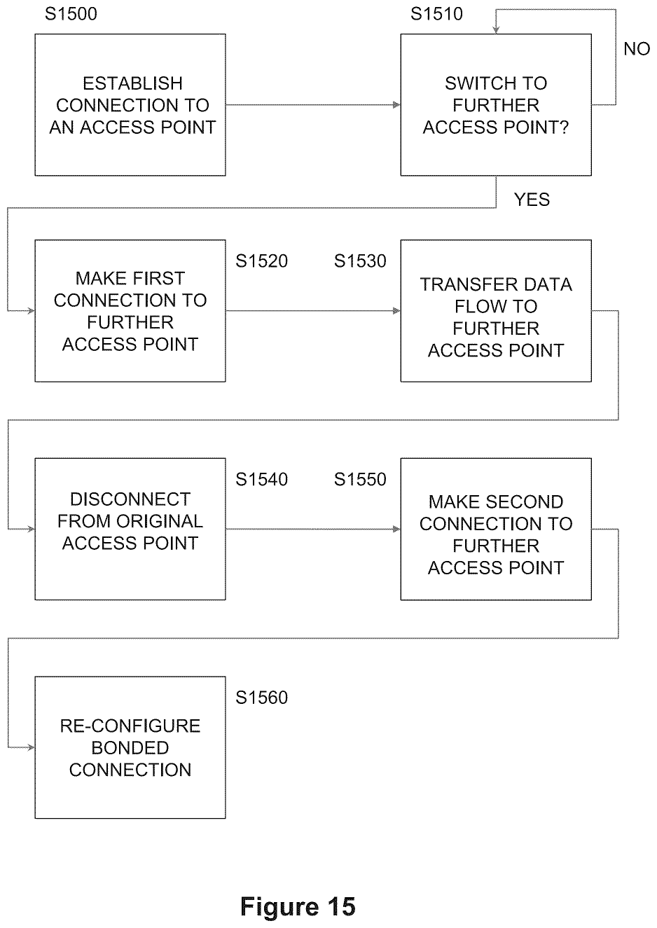

FIG. 15 shows a flow chart which provides a graphical depiction of a method according to the present disclosure. At step S1500 the bot has an established bonded connection to a wireless access point (as is described above with reference to FIG. 8). At step S1510 the bot determines whether to switch connection to a further access point. This determination may be made in response to the bot moving on the grid, a detected change in network conditions, a predetermined period of time having elapsed since the last iteration of S1510 having been performed etc. If it is determined that there is no need to switch to a further access point then the bot will wait and will perform S1510 again in due course (for example, due to the bot moving on the grid, a detected change in network conditions, elapsed period of time, etc.).

If it is determined that the bot should switch to a further access point then at S1520 the bot will connect to the further access point (see FIG. 10 and the associated discussion above). Once that connection has been made then at S1530 the data flow to the bot will be re-routed such that it is sent (and received) via the further access point (see FIG. 11 and the associated discussion above). At S1540 the bot will disconnect from the original access point and will make a connection to the further access point via the bonded wireless interface at S1550 (see FIG. 12 and the associated discussion above). As a bonded connection has now been established with the further access point, the method may terminate and the bot can be considered to return to step S1500.

Alternatively, the method may continue to include the optional step S1560 of re-configuring the bonded connection to the further access point (see FIG. 14 and the associated discussion above) before terminating. Again, the bot may be considered to be have returned to step S1500.

The access points and the wireless network interfaces may be selected to conform to one of the wireless LAN standards, such as IEEE 8021.11n (sometimes referred to WiFi 4), 802.11ac (WiFi 5) or 802.11ax (WiFi 6). As further technical standards are agreed upon (e.g., set, promulgated, or adopted) and compliant devices released then these may be adapted. The IEEE standard 8021.11be, a.k.a., WiFi 7 or Extremely High Throughput (EHT), is an example of a new standard that can be used within the scope of the present disclosure. It will be understood that standards-compliant devices will be selected to provide a desired level of network capacity and performance. It will be understood that standards-compliant devices will be selected to provide a desired level of network capacity and performance.

It will be understood from the foregoing discussion that the native capabilities of the access points and the wireless network interface can be used to manage channels, etc., in the wireless LAN. It will be understood that embodiments of the present disclosure can be implemented on or in software within (used by) the central computing system and/or the bot PC. One or more processing units/devices, e.g., CPUs, GPUs, or the like, may be utilized for a central computing system and/or bot within the scope of the present disclosure; where multiple processing units/devices are utilized, they may be linked, configured, and/or networked in any suitable way. Such computer code may be provided on physical media, for example, DVD, CD-ROM, USB memory stick, etc. or may be made available for download and installation. Any suitable computer code or programming language may be used within the scope of the present disclosure.

According to an aspect there is provided a load handling device designed to operate on the top of a cubic automated storage and retrieval system (ASRS). The load handling device comprises two wireless network interfaces which can be bonded into a single wireless connection with a wireless access point. In use, one of the wireless network interfaces can be used to connect to a further wireless access point. Data may then flow from the ASRS to the load handling device via the further wireless access point. The bonded connection may then be re-configured to connect via the further wireless access point.

What is claimed is:

1. A method of operating a load-handling device within a storage and retrieval system, the method comprising the steps of:
(a) establishing a first wireless connection between the load-handling device and a first wireless access point, wherein
(i) the load-handling device comprises a first wireless interface and a second wireless interface,
(ii) the first wireless connection is a bonded connection used to transfer data between the storage and retrieval system and the load-handling device via the first wireless access point;
(iii) the first wireless interface and the second wireless interface are both bonded to the first connection, wherein the first wireless interface is an active interface and the second wireless interface is a backup interface;
(b) establishing a second wireless connection between the load handling device and a second wireless access point when one or more conditions are met, such that;
(iv) the second wireless interface is removed from the bonded first wireless connection;
(v) the second wireless connection is made between the second wireless interface of the load handling device and the second wireless access point.

2. A method according to claim 1, wherein data is transferred between the storage system and the load handling device via the second wireless access point and the second wireless connection.

3. A method according to claim 2, wherein no data is transferred between the storage system and the load handling device via the first wireless access point.

4. A method according to claim 3, wherein the first wireless interface ends the wireless connection with the first wireless access point and makes a wireless connection to the second wireless access point.

5. A method according to claim 4, wherein the first wireless interface and the second wireless interface are both bonded to the second connection, wherein the second wireless interface is an active interface and the first wireless interface is a backup interface.

6. A method according to claim 5, wherein the second wireless connection is reconfigured such that the first wireless interface is the active interface and the second wireless interface is the backup interface and thus data is transferred between the storage system and the load handling device via the second wireless connection and the first wireless interface.

7. A method according to claim 1, wherein in step (b) the one or more condition that is met in order to establish the second wireless connection relates to the received signal strength of the first wireless access point and/or the received signal strength of the second wireless access point.

8. A method according to claim 7, wherein in step (b) the one or more condition that is met in order to establish the second wireless connection relates to the error rate in the first wireless connection.

9. A load handling device for use in a storage system, the load handling device comprising a first network interface and a second network interface, the load handling device being configured, in use, to establish first and second wireless connections between the load-handling device and first and second wireless access points, respectively..

10. A load handling device according to claim 9, the load handling device further comprising a wheel assembly arranged to selectively move in one of two orthogonal directions and a container lifting device arranged, in use, to lift a container from one of the plurality of stacks into the interior of the load handling device.

11. A storage system comprising:
a plurality of load handling devices, each configured to comprising a first network interface and a second network interface, the load handling device being configured, in use, to establish first and second wireless connections between the load-handling device and first and second wireless access points, respectively; and
a first set of parallel rails extending in an X-direction, and a second set of parallel rails extending in a Y-direction transverse to the first set in a substantially horizontal plane to form a grid pattern comprising a plurality of grid spaces; a plurality of stacks of containers located beneath the rails, and arranged such that each stack is located within a footprint of a single grid space;
wherein each of the plurality of load handling devices is arranged to selectively move in the X and/or Y directions, above the stacks on the rails and arranged to transport a container.

12. The storage system according to claim 11, wherein the at least one load handling device has a footprint that occupies only a single grid space in the storage system, such that a load handling device occupying one grid space does not obstruct a load handling device occupying or traversing the adjacent grid spaces in the X and/or Y directions.
